(19) United States
(12) Patent Application Publication
(10) Pub. No.: US 2014/0184944 A1
(43) Pub. Date: Jul. 3, 2014

(54) ARRAY SUBSTRATE AND TOUCH SCREEN WITH HORIZONTAL ELECTRIC FIELD DRIVING MODE

(71) Applicant: Shanghai Tianma Micro-Electronics Co., Ltd., Shanghai (CN)

(72) Inventors: Jun MA, Shanghai (CN); Lijun Zhao, Shanghai (CN); Qijun Yao, Shanghai (CN)

(73) Assignee: Shanghai Tianma Micro-Electronics Co., Ltd., Shanghai (CN)

(21) Appl. No.: 14/083,321

(22) Filed: Nov. 18, 2013

(30) Foreign Application Priority Data
Dec. 31, 2012 (CN) 201210592038.3

(51) Int. Cl. G02F 1/1333

(52) U.S. Cl. CPC G02F 1/13338
USPC 349/12

(57) ABSTRACT

An array substrate and a touch screen adopt a horizontal electric field driving mode. The array substrate with the horizontal electric field driving mode comprises a substrate, a plurality of common electrode lines formed on the substrate, and a plurality of gate lines formed on the substrate and a plurality of data lines intersecting the gate lines. The common electrode lines function as sensing electrodes or driving electrodes and the data lines or the gate lines function as the driving electrodes or the sensing electrodes during a touch period. The touch screen with the horizontal electric field driving mode can reduce the number of manufacturing processes, lower the production cost, and meanwhile, reduce the touch noise caused by a liquid crystal layer, thereby increasing the touch sensitivity efficiently.

### CROSS-REFERENCES TO RELATED APPLICATIONS

This application claims the benefit of priority to Chinese Patent Application No. 201210592038.3, entitled “ARRAY SUBSTRATE AND TOUCH SCREEN WITH HORIZONTAL ELECTRIC FIELD DRIVING MODE”, filed with the Chinese Patent Office on Dec. 31, 2012, the contents of which is incorporated herein by reference in its entirety.

### TECHNICAL FIELD

The present invention relates to flat panel display technologies, in particular to an array substrate and a touch screen with a horizontal electric field driving mode.

### BACKGROUND OF THE INVENTION

A touch screen built in a liquid crystal display can be integrated on a color filter substrate or an array substrate to reduce a thickness of an entire touch display device effectively, and hence is widely used. As for the liquid crystal display with a horizontal electric field driving mode such as a Fringe Field Switching (FFS) mode or an In-Plane Switching (IPS) mode, it is generally required for the In-Cell touch screen to arrange driving lines and sensing lines which are used for a touch function at one side of the color filter substrate.

As shown in FIG. 1, an FFS In-Cell touch screen 100 includes a color filter substrate 101, an array substrate 102, a liquid crystal layer 103 and a touch layer 104. The color filter substrate 101 and the array substrate 102 are arranged opposite to each other, the liquid crystal layer 103 is disposed between the color filter substrate 101 and the array substrate 102, and the touch layer 104 is integrated on the color filter substrate 101. The touch layer 104 includes a first metal layer 1041, a dielectric layer 1042 formed on the first metal layer 1041, and a second metal layer 1043 formed on the dielectric layer 1042, where, the first metal layer 1041 and the second metal layer 1043 are used as a driving electrode and a sensing electrode, respectively. It can be seen that a photoetching process is conducted three times on the color filter substrate 101 to form the first metal layer 1041, the dielectric layer 1042 and the second metal layer 1043, respectively, in order to form the above-described touch layer 104, leading to complicated processes and high production costs.

Furthermore, it can also be seen from FIG. 1 that, in the FFS In-Cell touch screen 100, parasitic capacitance C is generated between the touch layer 104 formed on the color filter substrate 101 and a common electrode layer 1021 formed on the array substrate 102. The touch screen may be used to detect a touch signal during a touch. The liquid crystal layer 103 contributes to the parasitic capacitance C, that is, the liquid crystal layer 103 is a part of touch capacitance. When the FFS In-Cell touch screen 100 operates in a display state, liquid crystal molecules of the liquid crystal layer 103 are rotated continually causing a change in dielectric constant of the liquid crystal layer 103, and hence leading to a corresponding change in the touch capacitance. Thus, the liquid crystal layer 103 generates a touch noise of the touch capacitance. The touch noise generated by the liquid crystal layer 103 leads to the decreased touch sensitivity of the FFS In-Cell touch screen 100.

### BRIEF SUMMARY OF THE INVENTION

The present invention provides an array substrate and a touch screen with a horizontal electric field driving mode, to simplify a manufacturing process for an In-Cell touch screen with the horizontal electric field driving mode, thereby reducing production costs of the In-Cell touch screen.

Another object of the invention is to solve the problem of the touch noise generated by a liquid crystal layer of the touch screen with the horizontal electric field driving mode, thereby increasing the touch sensitivity of the touch screen.

Embodiments of the present invention provide an array substrate with a horizontal electric field driving mode for solving the problems mentioned above. The array substrate comprises:
a substrate;
a plurality of common electrode lines formed on the substrate; and
a plurality of gate lines formed on the substrate and a plurality of data lines intersecting the gate lines.

In an embodiment, the common electrode lines may function as sensing electrodes or driving electrodes and the data lines may function as the driving electrodes or the sensing electrodes during a touch period;

In an embodiment, the common electrode lines are arranged perpendicular to the data lines.

In an embodiment, the common electrode lines function as the sensing electrodes and the data lines function as the driving electrodes during the touch period.

In an embodiment, the common electrode lines function as the driving electrodes and the data lines function as the sensing electrodes during the touch period.

In an embodiment, the common electrode lines are arranged perpendicular to the gate lines.

In an embodiment, the common electrode lines function as the sensing electrodes and the gate lines function as the driving electrodes during the touch period.

In an embodiment, the common electrode lines function as the driving electrodes and the gate lines function as the sensing electrodes during the touch period.

In an embodiment, each of the common electrode lines has a width in a range from about 3 mm to about 5 mm.

In an embodiment, the array substrate further comprises a plurality of pixel rows and a plurality of pixel columns formed by the plurality of data lines and the plurality of gate lines.

In an embodiment, the common electrode lines may overlap the pixel rows or the pixel columns.

In an embodiment a data line and a gate line adjacent to each other define a pixel region, and the pixel region includes a pixel electrode.

In an embodiment, the pixel region comprises a plurality of pixel electrodes that are connected together.

In an embodiment, a pixel electrode is formed in the pixel region.

In an embodiment, the pixel electrode is formed above the pixel common electrodes. In another embodiment, the pixel electrode is formed below the pixel common electrodes.

Embodiments of the present invention also provide a touch screen with a horizontal electric field driving mode. The touch screen comprises: an array substrate with the horizontal electric field driving mode as described above, a color filter substrate, and a liquid crystal layer disposed between the array substrate and the color filter substrate.

In an embodiment, the array substrate has a touch surface facing a user.

According to an embodiment, on the array substrate with the horizontal electric field driving mode, the common electrode is split to form the plurality of common electrode lines, which function as the sensing electrodes or the driving electrodes while the data lines or the gate lines function as the driving electrodes or the sensing electrodes during the touch period. That is, the common electrode lines function as the sensing electrodes or the driving electrodes during the touch period, and function as the common electrode during a display period. Likewise, the data lines or the gate lines function as the driving electrodes or the sensing electrodes during the touch period, and still function as the data lines or the gate lines during the display period. That is, based on the existing manufacturing of the common electrode, the data lines and the gate lines on the array substrate with the horizontal electric field driving mode, both the display function and the touch function can be implemented without adding other additional processes, so that the processes are reduced significantly and hence production costs are reduced greatly.

In another aspect of the present invention, since the common electrode, the data lines or the gate used for implementing the touch function are all located on the same array substrate, the metal layer used as the touch layer is no longer required on the color filter substrate, and the parasitic capacitance involving the liquid crystal layer is not generated between the array substrate and the color filter substrate, therefore, the detection of the touch capacitance is not affected by the rotation of the liquid crystal molecules in a driving electric field, that is, the rotation of the liquid crystal molecules no longer causes the touch noise, thereby increasing the touch sensitivity of the touch screen effectively.

### BRIEF DESCRIPTION OF THE DRAWINGS

FIG. 1 is a schematic view showing the structure of an FFS In-Cell touch screen in the prior art;

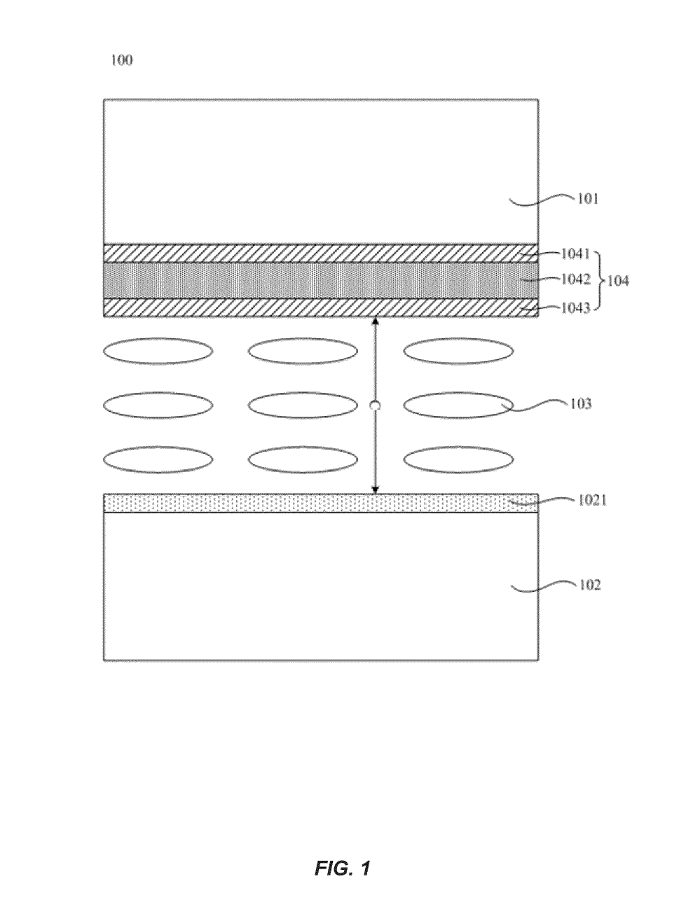

FIG. 2 is a top view of an array substrate with an FSS mode according to a first embodiment of the invention;

FIG. 3 is an enlarged partial view of a pixel region P of FIG. 2;

FIG. 4 is a sectional view along a line I-I′ of FIG. 3;

FIG. 5 is a top view of an array substrate with an In-Plane Switching mode according to a second embodiment of the invention;

FIG. 6 is an enlarged partial view of the pixel region P of FIG. 5;

FIG. 7 is a sectional view along a line I-I′ of FIG. 6;

FIG. 8 is a top view of an array substrate with a horizontal electric field driving mode according to a third embodiment of the invention;

FIG. 9 is a top view of an array substrate with the horizontal electric field driving mode according to a fourth embodiment of the invention; and

FIG. 10 a schematic view of the structure of a touch screen with the horizontal electric field driving mode according to a fifth embodiment of the invention.

### DETAILED DESCRIPTION OF THE INVENTION

The concept of the present invention lies in splitting an integral common electrode arranged on an array substrate with a horizontal electric field driving mode in the prior art to form a plurality of common electrode lines, which then also function as sensing electrodes or driving electrodes, meanwhile, data lines or gate lines also function as driving electrodes or sensing electrodes, for the purpose of integrating the touch function layer on the array substrate without increasing processing steps.

The improvements of the present invention are made on the array substrate with the horizontal electric field driving mode, including a Fringe Field Switching mode or an In-Plane Switching mode, for example.

For a better understanding of the objects, solutions and advantages of the invention, the invention is described in detail below in conjunction with the accompanying drawings.

### First Embodiment

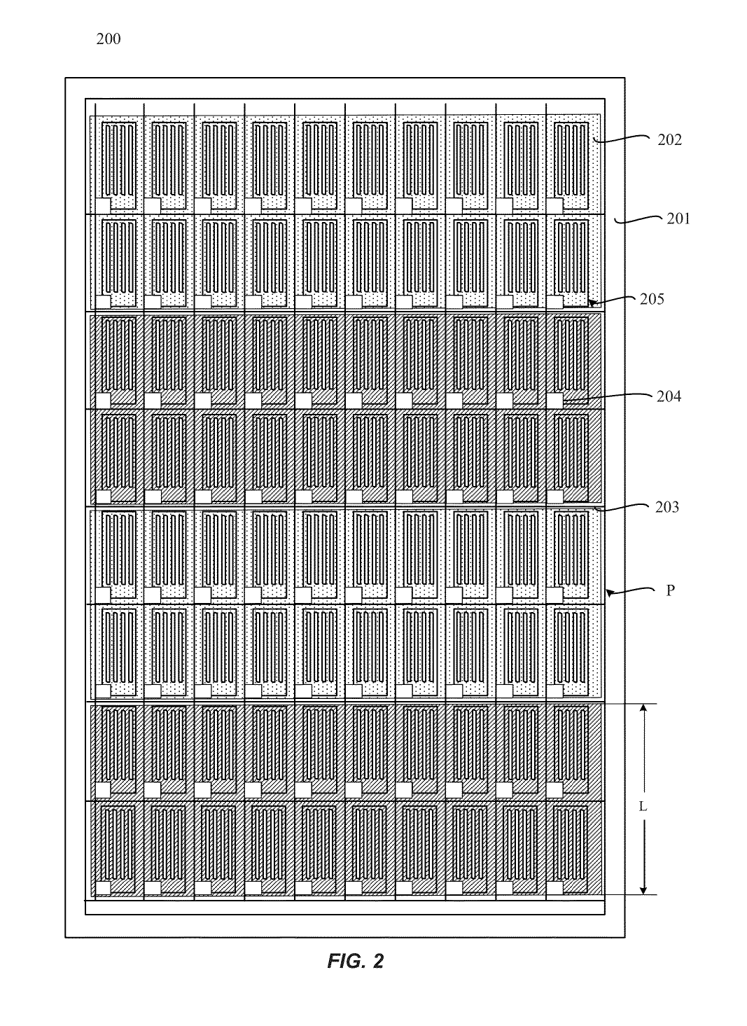

As shown in FIG. 2, an array substrate 200 with a Fringe Field Switching mode according to a first embodiment includes a substrate 201, a plurality of common electrode lines 202 formed on the substrate 201, a plurality of gate lines 203 formed on the substrate 201, and a plurality of data lines 204 intersecting the gate lines 203, where an adjacent data line 204 and gate line 203 define a pixel region P. The width L of the common electrode line 202 can be selected as required, for example, the width of the common electrode line may range from 3 mm to 5 mm. For clarity of illustration, adjacent common electrode lines 202 have different shades as shown in FIG. 2.

Further referring to FIG. 2, the common electrode lines 202 are arranged perpendicular to the data lines 204. During a touch period, the common electrode lines 202 function as sensing electrodes for realizing a touch function, and the data lines 204 function as driving electrodes for realizing the touch function. Of course, it is also possible that the common electrode lines 202 function as the driving electrodes and the data lines 204 function as the sensing electrodes.

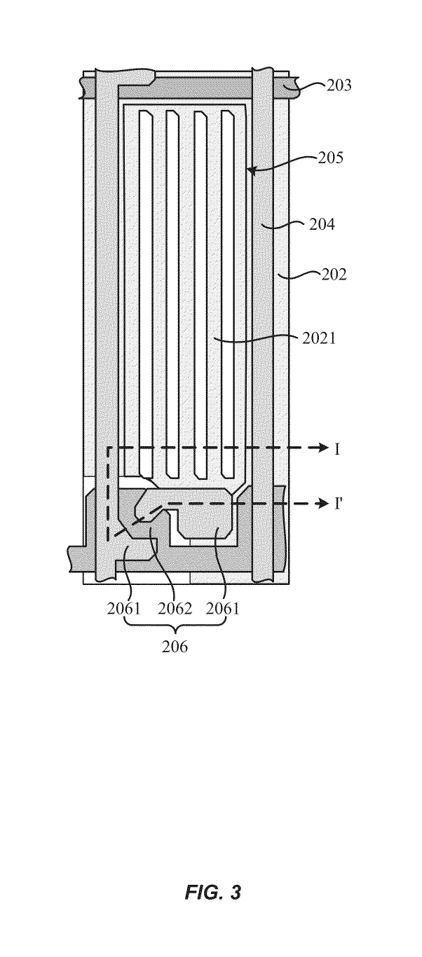

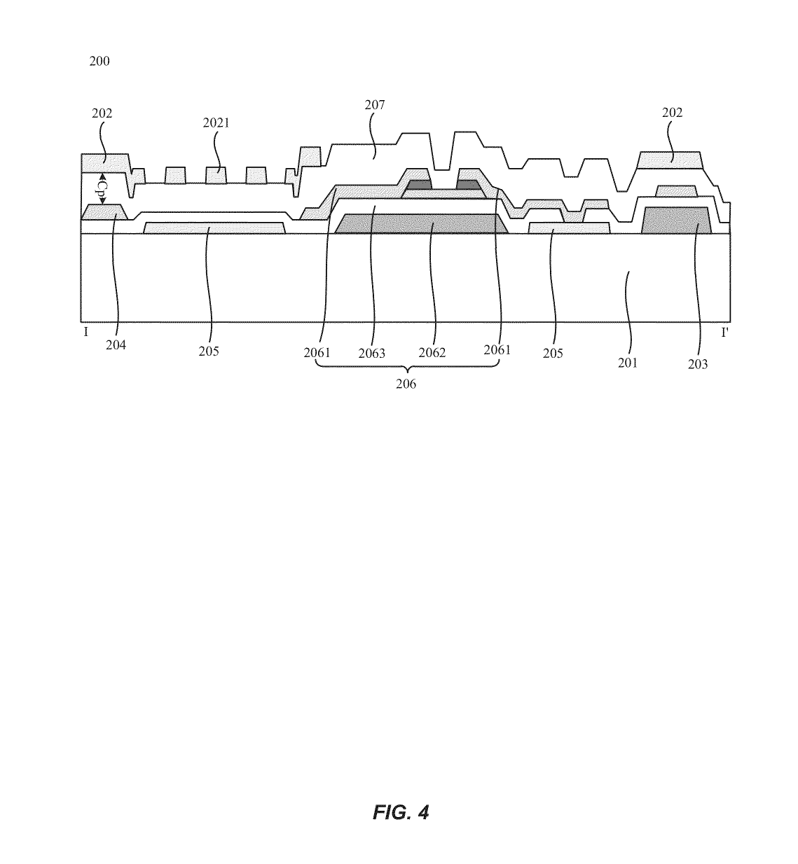

As shown in FIG. 3 in combination with FIG. 4, each pixel region P includes a pixel electrode 205 formed on the substrate 201, and the pixel electrode 205 is connected with one end of a source/drain 2061 of a thin film transistor 206 by a through-hole. The thin film transistor 206 also includes a gate 2062 and a gate insulation layer 2063 that are formed on the substrate 201, the gate 2062 is formed on the substrate 201, the gate insulation layer 2063 is formed on the gate 2062, the pixel electrode 205 and the substrate 201, and both the data lines 204 and the source/drain 2061 are formed on the gate insulation layer 2063. Here, the gate 2062 is connected with the gate lines 203, and the other end of the source/drain 2061 is connected with the data lines 204. Furthermore, a protect layer 207 is formed on the gate insulation layer 2063 of the thin film transistor 206, the data lines 204 and the source/drain 2061; the common electrode line 202 is formed on the protect layer 207 and split to form a plurality of pixel common electrodes 2021 in the pixel region P by an etching process, and the plurality of pixel common electrodes 2021 in the pixel region are all connected with the same common electrode line 202. Since the common electrode line 202 is arranged perpendicular to the data line 204, the common electrode line 202 certainly includes an area facing the data line 204, thereby forming a first capacitance C_{P}. The common electrode line 202 functions as the driving electrode or the sensing electrode while the data line functions as the sensing electrode or the driving electrode during the touch period, at this time, the first capacitance C_{P} functions as the touch capacitance.

In the first embodiment, the pixel electrode 205 is formed below the pixel common electrodes 2021, that is, the Top COM form is utilized. It should be understood that embodiments of the present invention are also applicable to the Bottom COM form, that is, the pixel common electrodes 202 are formed above the substrate 201, and the pixel electrode 205 is located above the protect layer 207.

### Second Embodiment

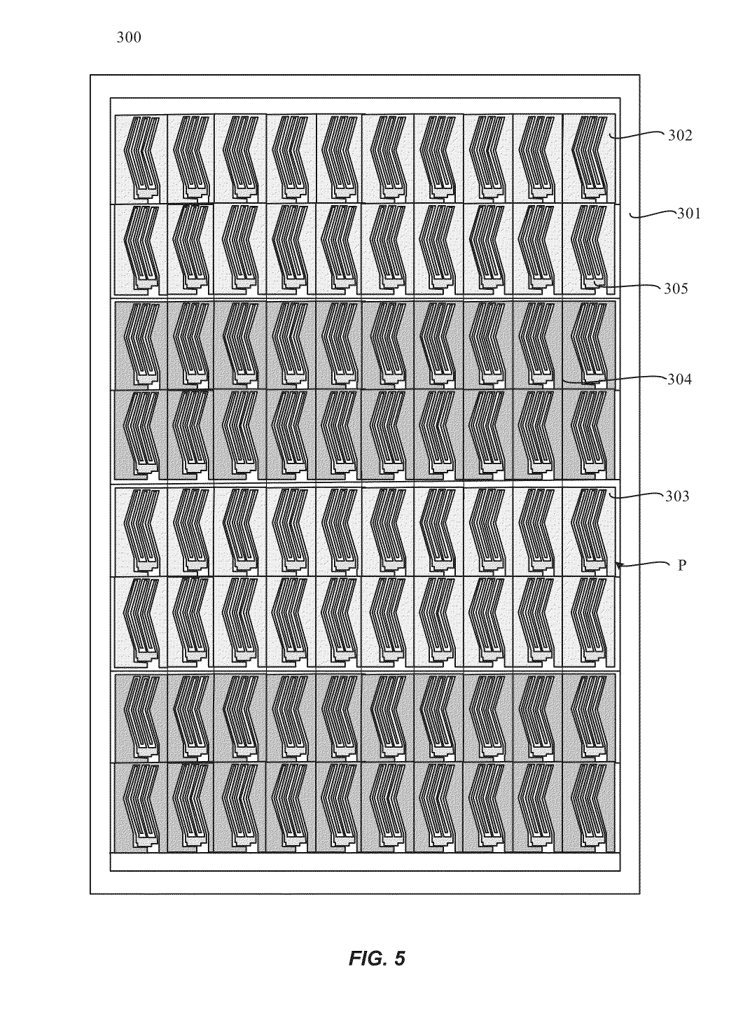

As described above, the concept of the present invention is applicable to any array substrate with a horizontal electric field driving mode. As shown in FIG. 5, an array substrate 300 with an In-Plane Switching mode as provided in the second embodiment includes a substrate 301, a plurality of common electrode lines 302 formed on the substrate 301, a plurality of gate lines 303 formed on the substrate 301, and a plurality of data lines 304 intersecting the gate lines 303, where a region defined by the adjacent data line 304 and gate line 303 is a pixel region P. The common electrode lines 302 are arranged perpendicular to the data lines 304. The common electrodes 302 function as sensing electrodes or driving electrodes for realizing the touch function and the data lines 304 function as the driving electrodes or the sensing electrodes for realizing the touch function during a touch period.

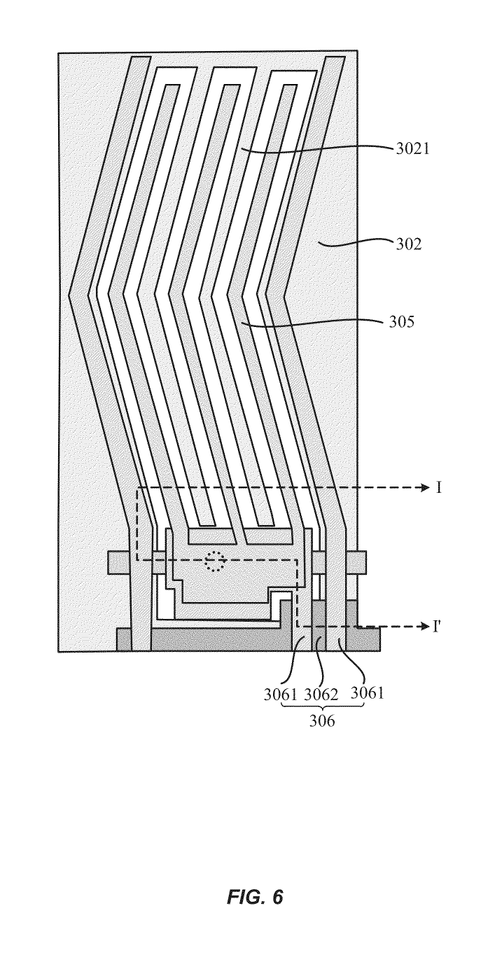

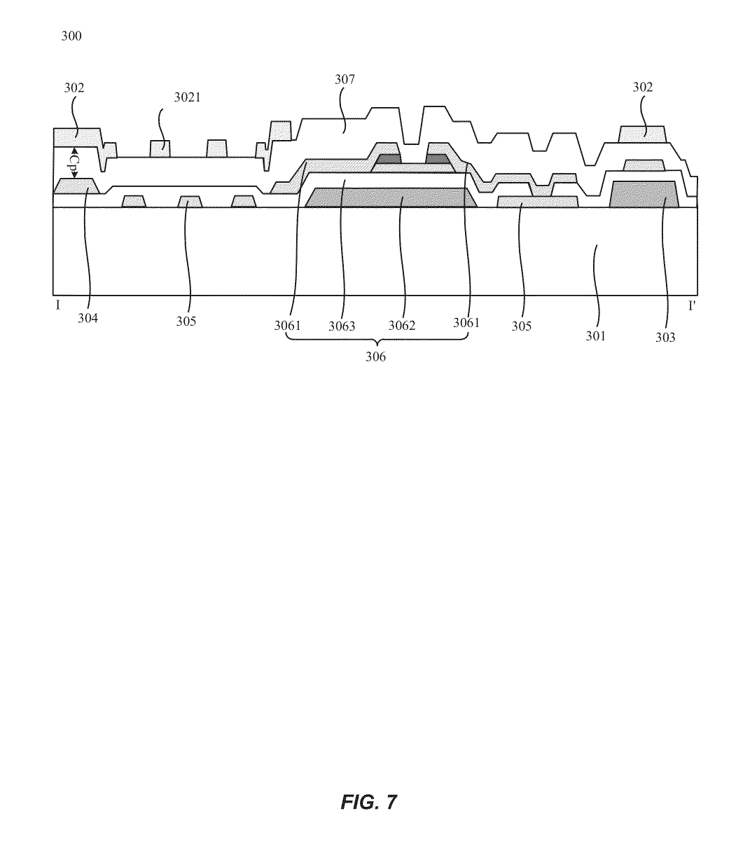

As shown in FIGS. 6 and 7, each pixel region P includes a plurality of pixel electrodes 305 connected together. The pixel electrodes 305 are formed on the substrate 301 and connected with one end of a source/drain 3061 of a thin film transistor 306 via a through hole. The thin film transistor 306 also includes a gate 3062 and a gate insulation layer 3063 formed on the substrate 301, the gate 3062 is formed on the substrate 301, the gate insulation layer 3063 is formed on the gate 3062, the pixel electrodes 305 and the substrate 301, and both the data lines 304 and the source/drain 3061 are formed on the gate insulation layer 3063. Here, the gate 3062 is connected with the gate lines 303, the other end of the source/drain 3061 is connected with the data lines 304. Furthermore, a protect layer 307 is formed on the gate insulation layer 3063 of the thin film transistor 306, the data lines 304 and the source/drain 3061, the common electrode line 302 is formed on the protect layer 307 and split to form a plurality of pixel common electrodes 3021 in the pixel region P by an etching process, and the plurality of pixel common electrodes 3021 in the pixel region are all connected with the same common electrode line 302.

As shown in FIG. 7, in the array substrate 300 with the horizontal electric field driving mode, a horizontal electric field is generated between each of the plurality of pixel common electrodes 3021 and each of the pixel electrodes 305 in each pixel region, and drives liquid crystal molecules above the substrate 300 to rotate.

It should be understood that the concept of the present invention is also applicable to any other array substrates with the horizontal electric field driving mode.

### Third Embodiment

The third embodiment is different from the first and second embodiments by having different line widths of the common electrode lines, i.e., different numbers of the common electrode lines split from the entire common electrode as compared with the prior art.

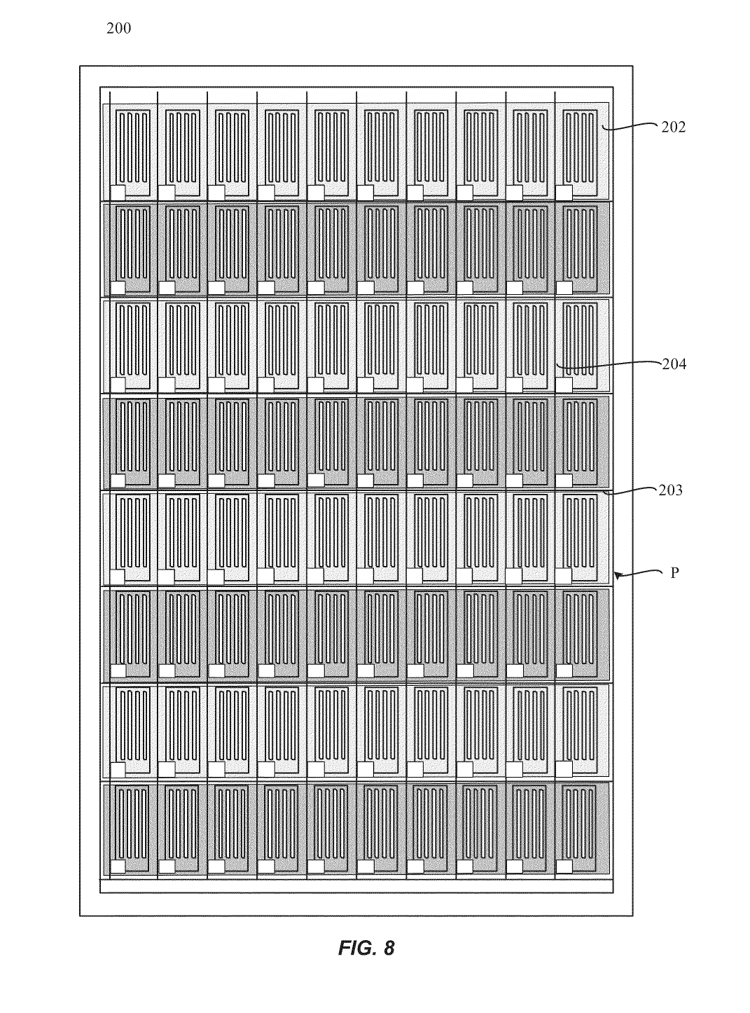

Specifically, as shown in FIG. 8, on an array substrate 200 with a horizontal electric field driving mode according to this embodiment, a plurality of pixel rows and a plurality of pixel columns are formed by the plurality of data lines 204 and the plurality of gate lines 203. The common electrode lines 202 are arranged to overlap with the pixel rows or pixel columns, that is, each of the common electrode lines 202 is corresponds to one pixel row.

Since each of the common electrode lines 202 corresponds to one pixel row, the touch function during a touch period does not affect the function of the common electrode 202 as a storage capacitance when the common electrode 202 operates in a display period, thereby optimizing the display effect. Further, when the common electrode line 202 is arranged to overlap with the pixel rows or pixel columns, other inversion manners other than a Dot Inversion can be used for display driving, thereby reducing the power consumption of a display device.

### Fourth Embodiment

This embodiment is different from the above-mentioned first, second, and third embodiments by that the data lines function as driving electrodes or sensing electrodes in the first, second and third embodiments, but gate lines function as the driving electrodes or the sensing electrodes in the fourth embodiment.

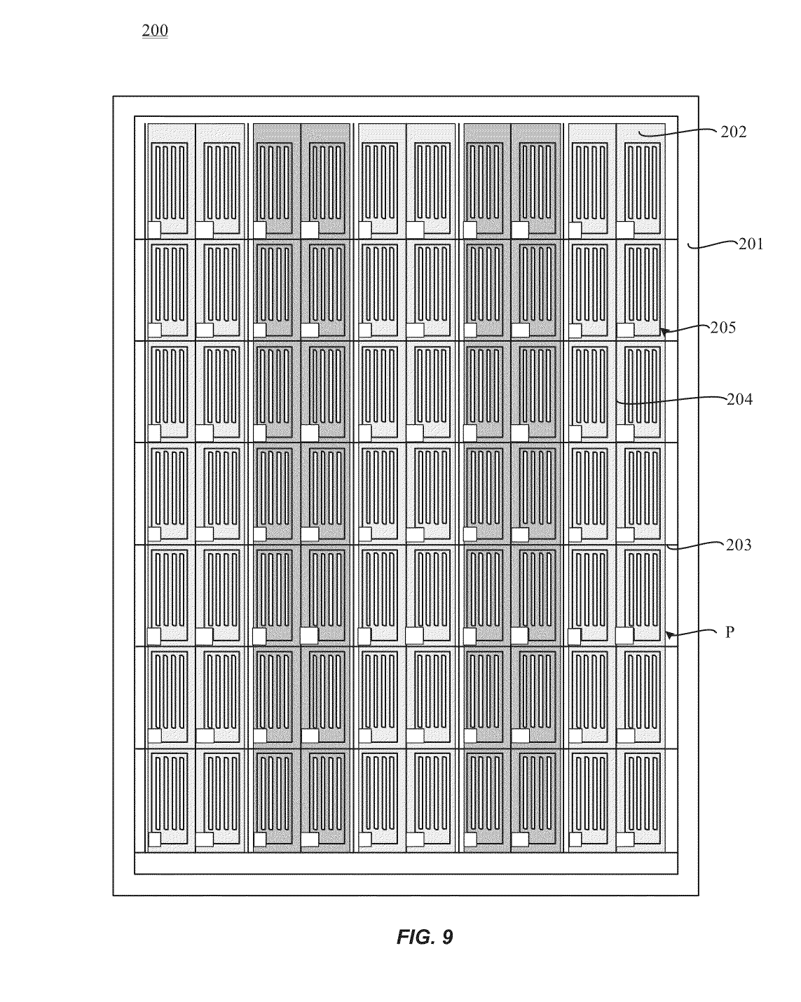

As shown in FIG. 9, an array substrate 200 with a horizontal electric field driving mode includes a substrate 201, a plurality of common electrode lines 202 formed on the substrate 201, a plurality of gate lines 203 formed on the substrate 201, and data lines 204 intersecting the gate lines 203, where a region defined by the adjacent data line 204 and gate line 203 is a pixel region P.

Further referring to FIG. 9, the common electrode lines 202 are arranged perpendicular to the gate lines 203. The common electrode lines 202 function as sensing electrodes for realizing a touch function and the gate lines 203 function as driving electrodes for realizing the touch function during a touch period. Of course, it is also possible that the common electrode lines 202 function as the driving electrodes and the gate lines 203 function as the sensing electrodes.

### Fifth Embodiment

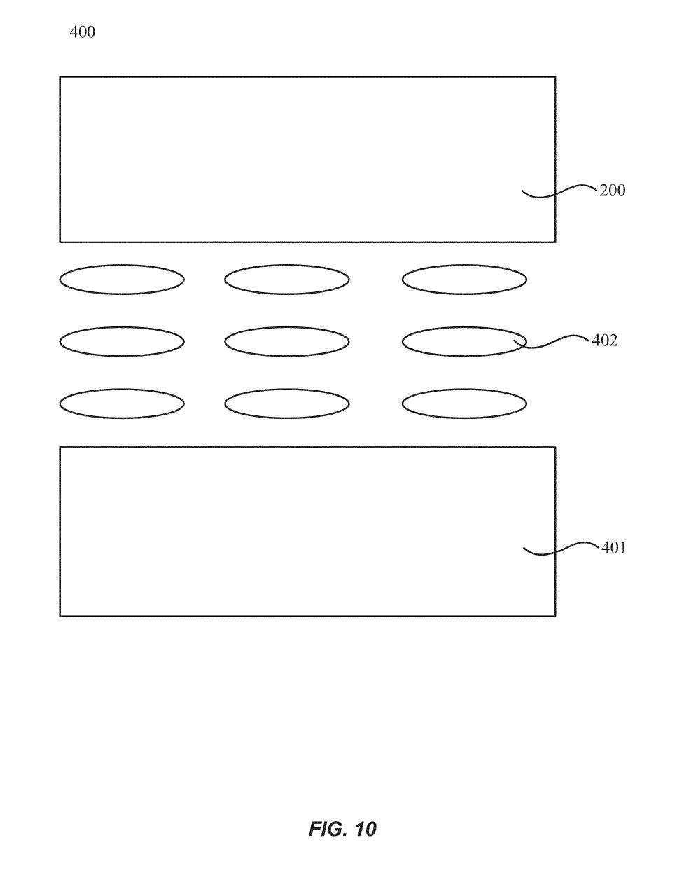

As shown in FIG. 10, embodiments of the present invention also provide a touch screen 400 with a horizontal electric field driving, which includes an array substrate 200 with an FFS driving mode or an array substrate 300 with an IPS driving mode as provided in any one of the first, second, third and fourth embodiments, a color filter substrate 401, and a liquid crystal layer 402 disposed between the array substrate 200 and the color filter substrate 401.

In order to further optimize the touch effect, a surface of the array substrate 200 that faces the user is arranged as a touch surface, so that the liquid crystal layer 402 is not involved in the capacitance generated between a finger of the user and the touch layer, thus the noise carried by a touch signal generated between the finger of the user and the touch layer is reduced.

As can be seen, in the above-mentioned touch screen with the horizontal electric field driving mode, the common electrode arranged on the array substrate is split to form a plurality of common electrode lines, which function as the sensing electrodes or the driving electrodes while the data lines or the gate lines function as the driving electrodes or the sensing electrodes during a touch period. That is, the common electrode lines function as the sensing electrodes or the driving electrodes during the touch period, and function as the common electrode during a display period. Likewise, the data lines or the gate lines function as the driving electrodes or the sensing electrodes during the touch period function as the data lines or gate lines in the display period. Therefore, no additional process is required to form the touch layer, and both the display function and the touch function are implemented, so that the process is simplified significantly and production costs are reduced greatly.

In another aspect, since the common electrode lines, the data lines or the gate lines used for implementing the touch function are all located on the same array substrate, a metal layer used as the touch layer is no longer required on the color filter substrate, and the parasitic capacitance involving the liquid crystal layer is not generated between the array substrate and the color filter substrate, therefore, the detection of the touch capacitance is not affected by the rotation of the liquid crystal molecules in the driving electric field, that is, the rotation of the liquid crystal molecules no longer generates the touch noise, as a result, the touch sensitivity of the touch screen can be improved effectively.

It should be noted that, embodiments are described in a step-up way in the description, that is, differences of each embodiment from the previous embodiments are described, but reference may be made to the previous embodiments for any identical or similar parts of each embodiment with respect to the previous embodiments.

Obviously, various modifications and variations may be made by those skilled in the art without departing from the principle and scope of the invention. Thus, all these modifications and variations are intended to be included in this invention if they fall within the scope of the appended claims and their equivalents.

What is claimed is:

1. An array substrate with a horizontal electric field driving mode, comprising:
a substrate;
a plurality of common electrode lines formed on the substrate; and
a plurality of gate lines formed on the substrate and a plurality of data lines intersecting with the gate lines;
wherein, the common electrode lines function as sensing electrodes or driving electrodes and the data lines function as the driving electrodes or the sensing electrodes during a touch period.

2. The array substrate of claim 1, wherein the common electrode lines are arranged perpendicular to the data lines.

3. The array substrate of claim 2, wherein the common electrode lines function as the sensing electrodes and the data lines function as the driving electrodes during the touch period.

4. The array substrate of claim 2, wherein the common electrode lines function as the driving electrodes and the data lines function as the sensing electrodes during the touch period.

5. The array substrate of claim 1, wherein the common electrode lines are arranged perpendicular to the gate lines.

6. The array substrate of claim 5, wherein, the common electrode lines function as the sensing electrodes and the gate lines function as the driving electrodes during the touch period.

7. The array substrate of claim 5, wherein, the common electrode lines function as the driving electrodes and the gate lines function as the sensing electrodes during the touch period.

8. The array substrate of claim 1, wherein each of the common electrode lines has a width in a range from 3 mm to 5 mm.

9. The array substrate of claim 1, further comprising a plurality of pixel rows and a plurality of pixel columns formed by the plurality of data lines and the plurality of gate lines.

10. The array substrate of claim 9, wherein the common electrode lines overlap the pixel rows or the pixel columns.

11. The array substrate of claim 1, wherein a data line and a gate line adjacent to each other defines a pixel region, the pixel region including a pixel electrode.

12. The array substrate of claim 11, wherein the pixel region comprises a plurality of pixel common electrodes connected together.

13. The array substrate of claim 12, wherein the pixel electrode is formed above the pixel common electrodes.

14. The array substrate of claim 12, wherein the pixel electrode is formed below the pixel common electrodes.

15. A touch screen with a horizontal electric field driving mode, comprising:
an array substrate with the horizontal electric field driving mode according to claim 1;
a color filter substrate; and
a liquid crystal layer disposed between the array substrate and the color filter substrate.

16. The touch screen of claim 14, wherein the array substrate comprises a touch surface facing a user.
